(19) United States
(12) Patent Application Publication
(10) Pub. No.: US 2026/0331024 A1
(43) Pub. Date: Oct. 22, 2026

(54) DISPLAY PANEL, MANUFACTURING METHOD THEREFOR AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Zheng BAO, Beijing (CN); Gong CHEN, Beijing (CN); Mingqiang WANG, Beijing (CN); Xueying HE, Beijing (CN); Haotian YANG, Beijing (CN); Yuan FANG, Beijing (CN); Lian XIANG, Beijing (CN); Wei GONG, Beijing (CN); Chang WANG, Beijing (CN); Jiaxiang ZHANG, Beijing (CN); Xiaoliang FU, Beijing (CN); Bin ZHANG, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 19/122,773

(22) PCT Filed: Jan. 15, 2024
(86) PCT No.: PCT/CN2024/072383

§ 371 Date: Apr. 21, 2025

(30) Foreign Application Priority Data
Feb. 22, 2023 (CN) 202310154408.3

(51) Int. Cl. G09G 3/20

(52) U.S. Cl. CPC G09G 3/2096; G09G 2300/0426; G09G 2310/0267; G09G 2310/0275; G09G 2310/0297; G09G 2320/0214; G09G 2320/0271; G09G 2330/021

(57) ABSTRACT

A display panel includes a switch circuit and a source drive circuit. The switch circuit includes a plurality of switch modules. For each switch module, a control terminal is used for receiving a switch control signal, a first terminal is used for receiving a data signal, and a second terminal is connected to a data line of a display area. The source drive circuit includes a data signal output module and voltage regulator modules, the data signal output module being used for outputting data signals via source signal lines connected thereto, and one source signal line being correspondingly connected to each switch module in one switch circuit. The number of the voltage regulator modules is less than or equal to the number of the switch modules in the switch circuit.

### CROSS-REFERENCE TO RELATED APPLICATIONS

The present disclosure is the U.S. national phase application of International Application No. PCT/CN 2024/072383 filed on Jan. 15, 2024, which claims priority to Chinese Patent Application No. 202310154408.3, filed on Feb. 22, 2023 and entitled “DISPLAY PANEL, MANUFACTURING METHOD THEREFOR, AND DISPLAY DEVICE”, the entire contents of each are incorporated herein by reference.

### TECHNICAL FIELD

The present disclosure relates to the field of display technology, in particular, to a display panel, a method for manufacturing the display panel, and a display device.

### BACKGROUND

Multiplex switches are usually used in flexible wearable devices, so as to save space. In the related technology, the flexible wearable devices are often of high power consumption.

It should be noted that the information disclosed in above section is only for the purpose of enhancing the understanding of the background of the present disclosure, and thus can include information that does not constitute prior art already known to those of ordinary skill in the art.

### SUMMARY

The purpose of the present disclosure is to overcome the deficiency in the related art and provide a display panel, a method for manufacturing the display panel, and a display device.

According to a first aspect of the present disclosure, a display panel is provided. The display panel includes multiple switch circuits, wherein the switch circuit includes: multiple switch modules, wherein a control terminal of the switch module is configured to receive a switch control signal, a first terminal of the switch module is configured to receive a data signal, and a second terminal of the switch module is connected to a data line in a display area; a source driving circuit, wherein the source driving circuit includes: a data signal output module configured to output the data signal through source signal lines connected thereto, wherein each source signal line corresponds to each switch circuit, and the source signal line is connected to the switch modules in the switch circuit corresponding thereto; and multiple voltage regulator modules configured to output the switch control signal; wherein a number of the voltage regulator modules is less than or equal to a number of switch modules in the switch circuit, and switch control signals output by at least some of the voltage regulator modules have different signal amplitudes.

In some embodiments of the present disclosure, switch modules connecting the same type of sub pixels to the source signal lines share the same voltage regulator module.

In some embodiments of the present disclosure, the number of the voltage regulator modules is the same as a number of the sub pixels in a pixel unit.

In some embodiments of the present disclosure, a pixel unit includes a first sub pixel (R), a second sub pixel (G), and a third sub pixel (B), and a maximum grayscale voltage of the second sub pixel>a maximum grayscale voltage of the first sub pixel>a maximum grayscale voltage of the third sub pixel; and wherein the source driving circuit includes a first voltage regulator module configured to output a first switch control signal, a second voltage regulator module configured to output a second switch control signal, and a third voltage regulator module configured to output a third switch control signal, and a signal amplitude of the second switch control signal>a signal amplitude of the first switch control signal>a signal amplitude of the third switch control signal.

In some embodiments of the present disclosure, a pixel unit includes m sub pixels, and the switch circuit includes n switch modules, where n and m are natural numbers, and n is an integer multiple of m; and wherein the source driving circuit further includes multiple signal transmission lines, each signal transmission line is connected to each switch module, and switch modules connected to the same type of sub pixels are connected to the same voltage regulator module through signal transmission lines corresponding thereto.

In some embodiments of the present disclosure, a voltage output module, wherein an output terminal of the voltage output module is connected to the voltage regulator modules, and the voltage output module is configured to output a reference voltage signal; and a digit module connected to the voltage regulator modules and the switch modules, wherein the digit module is configured to output the switch control signal to a switch module corresponding to the switch control signal according to a preset timing; wherein the voltage regulator modules are further configured to adjust the reference voltage signal into a switch control signal having a corresponding amplitude; the signal transmission line includes a first segment and a second segment, the first segment is connected between the digit module and the switch module, and the second segment is connected between the voltage regulator module and the digit module.

In some embodiments of the present disclosure, the display panel further includes a gate driving circuit, wherein the gate driving circuit is configured to perform row scanning of the display panel; and wherein the gate driving circuit and the voltage regulator modules share the same voltage output module.

In some embodiments of the present disclosure, a voltage regulator circuit includes a linear low dropout regulator.

In some embodiments of the present disclosure, the switch circuit is a multiplexer, and the switch module is a transistor.

In some embodiments of the present disclosure, the non-display area includes a transition area and a binding area, the transition area is connected between the display area and the binding area, the source driving circuit is located in the binding area, and the switch circuits are located in the transition area; and wherein a width of the transition area in a first direction is less than a width of the binding area in the first direction, and the first direction intersects with an overall extension direction from the display area to the binding area.

In some embodiments of the present disclosure, the width of the transition area in the first direction gradually decreases along a direction pointing from the binding area to the display area.

In some embodiments of the present disclosure, the display panel further includes: a base substrate; an active layer located on a side of the base substrate, wherein the active layer includes: multiple first active parts, wherein orthographic projections of the first active parts on the base substrate are distributed at intervals along the first direction, the first active part includes a first sub-active part, a second sub-active part, and a third sub-active part, connected in sequence along the first direction, and the first sub-active part and the third sub-active part are used to form channel regions of the switch module; a first conductive layer located on a side of the active layer away from the base substrate, wherein the first conductive layer includes: multiple first conductive parts arranged in one-to-one correspondence with the first active parts, wherein the first conductive part includes a first sub-conductive part, a second sub-conductive part, and a third sub-conductive part, connected in sequence, an orthographic projection of the first sub-conductive part on the base substrate covers the orthographic projection of the first sub-active part on the base substrate, an orthographic projection of the third sub-active part on the base substrate covers the orthographic projection of the third sub-active part on the base substrate, and the first sub-conductive part and the second sub-conductive part are used to form a control terminal of the switch module; wherein the second sub-conductive part is connected between the first sub-conductive part and the third sub-conductive part on a side where the first sub-conductive part and the third sub-conductive part are away from the display area.

In some embodiments of the present disclosure, an orthographic projection of the second sub-conductive part on the base substrate is separated from an orthographic projection of the third sub-active part on the base substrate.

In some embodiments of the present disclosure, the active layer includes multiple repeating units, a number of the repeating units is the same as a number of the switch circuits, the repeating unit includes f active structures, and each active structure includes two first active parts; and wherein the switch circuit includes k switch modules, if k is odd, f=(k+1)/2, and if k is even, f=k/2.

In some embodiments of the present disclosure, the active structure further includes: a second active part connected between two adjacent first active parts, wherein the second active part is used to form first terminals of two adjacent switch modules; and two third active parts connected to a side where one of the first active parts is away from the other one of the first active parts, wherein the third active parts are used to form second terminals of the two adjacent switch modules; and wherein the display panel further includes: a second conductive layer located on a side of the first conductive layer away from the base substrate, wherein the second conductive layer includes: the source signal lines, wherein orthographic projections of the source signal lines extend along a second direction and are distributed at intervals along the first direction; a third conductive layer located on a side of the second conductive layer away from the base substrate, wherein the third conductive layer includes: multiple first trans-connection lines, wherein each first trans-connection line and each source signal line are in one-to-one correspondence, and the first trans-connection line includes: a first connection part, wherein an orthographic projection of the first connection part on the base substrate extends along the first direction; and multiple second connection parts, wherein the multiple second connection parts are in one-to-one correspondence with multiple second active parts and are connected to the first connection part, orthographic projections of the second connection parts on the base substrate extend along the second direction, and the second connection parts are further connected to the second active parts corresponding thereto through via holes; multiple signal transmission lines, wherein the signal transmission line includes: a first transmission part, wherein an orthographic projection of the first transmission part on the base substrate extends along the first direction, and the first transmission part is connected to the first sub-conductive part corresponding thereto through a via hole; and a second transmission part connected to the first transmission part and the voltage regulator module corresponding thereto, and an orthographic projection of the second transmission part on the base substrate extends along the second direction; and multiple second trans-connection lines arranged in one-to-one correspondence with the third active parts, wherein orthographic projections of the second trans-connection lines on the base substrate extend along the second direction and are distributed at intervals along the first direction, and the second trans-connection lines are connected to the third active parts corresponding thereto through via holes and to the data lines corresponding thereto.

According to a second aspect of the present disclosure, a method for manufacturing a display panel as described in any embodiment of the present disclosure is also provided. The method includes: providing a base substrate, wherein the base substrate has a display area and a non-display area located at least on a side of the display area, the display area includes multiple pixel units arranged in an array along a row direction and a column direction, and the pixel unit includes multiple types of sub pixels having different maximum grayscale voltages; forming an active layer on a side of the base substrate using a deposition process, wherein the active layer includes multiple first active parts, orthographic projections of the multiple first active parts on the base substrate are distributed at intervals along a first direction, the first active part includes a first sub-active part, a second sub-active part, and a third sub-active part which are connected in sequence along the first direction, and the first sub-active part and the third sub-active part are used to form channel regions of a switch module; and forming a first conductive layer on a side of the active layer away from the base substrate using a deposition process, wherein the first conductive layer includes multiple first conductive parts, and the first conductive parts and the first active parts are arranged in one-to-one correspondence, and wherein the first conductive part includes a first sub-conductive part, a third sub-conductive part, and a second sub-conductive part, which are connected in sequence, an orthographic projection of the first sub-conductive part on the base substrate covers an orthographic projection of the first sub-active part on the base substrate, an orthographic projection of the second sub-conductive part on the base substrate covers an orthographic projection of the second sub-active part on the base substrate, the first sub-conductive part and the second sub-conductive part are used to form control terminals of the switch module, and the third conductive part is connected between the first conductive part and the second conductive part on a side where the first conductive part and the second conductive part are away from the display area.

According to a third aspect of the present disclosure, a display device including a display panel as described in any embodiment of the present disclosure is also provided.

The display panel provided by the present disclosure includes a source driving circuit and a switch circuit. One switch circuit includes multiple switch modules, and one switch module is connected to one data line to output a data signal to a sub-pixel column. The source driving circuit includes multiple voltage regulator modules. The signal amplitude of the switch control signal output by the voltage regulator module is proportional to the maximum grayscale voltage of the sub pixel corresponding to the switch control signal. In other words, the voltage regulator modules corresponding to different sub pixels can output voltage signals of different signal amplitudes. Therefore, compared to the prior art where only voltage signals having the same signal amplitude are output to control different switch modules in the switch circuit, the source driving circuit provided by the present disclosure can reduce the overall power consumption.

It should be understood that the general description in the above and the detailed description in the following are only illustrative and explanatory, and do not limit the present disclosure.

### BRIEF DESCRIPTION OF THE DRAWINGS

The drawings herein, which are incorporated in and constitute a portion of this specification, illustrate embodiments consistent with the present disclosure and serve together with the specification to explain principles of the present disclosure. It is apparent that the drawings in the following description are only some embodiments of the present disclosure, and other drawings can be obtained based on the drawings by those of ordinary skill in the art without creative efforts.

FIG. 1 is a schematic diagram of a structure of a display panel according to embodiments of the present disclosure;

FIG. 2 is a schematic diagram of connections between a switch circuit in FIG. 1 and other devices;

FIG. 3 is a schematic diagram of connections between a switch circuit in FIG. 1 and other devices according to other embodiments;

FIG. 4 is a schematic diagram of a structure of a voltage regulator circuit according to embodiments of the present disclosure;

FIG. 5 is a schematic diagram of a structure of a switch circuit and other devices according to embodiments of the present disclosure;

FIG. 6 is a cross-sectional view taken along a dashed line AA in FIG. 5; and

FIGS. 7-15 are process flow diagrams of a method for manufacturing a display panel according to embodiments of the present disclosure.

### DETAILED DESCRIPTION

Example embodiments will now be described more fully with reference to the drawings. However, example embodiments can be implemented in a variety of forms and should not be construed as being limited to the embodiments set forth herein. Rather, the provision of these embodiments makes the present disclosure comprehensive and complete and conveys ideas of the example embodiments in a comprehensive manner to those skilled in the art. The same reference numerals in the drawings indicate the same or similar structures, and thus their detailed description will be omitted. In addition, the drawings are only schematic illustrations of the present disclosure and are not necessarily drawn to scale.

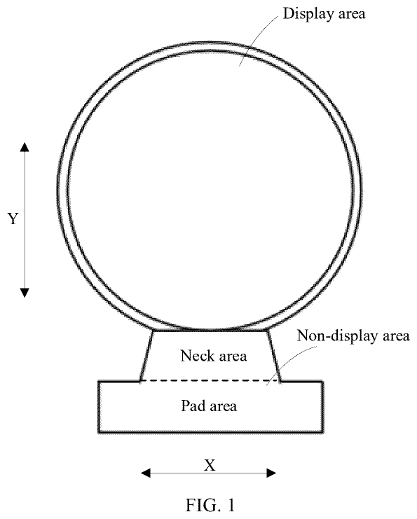

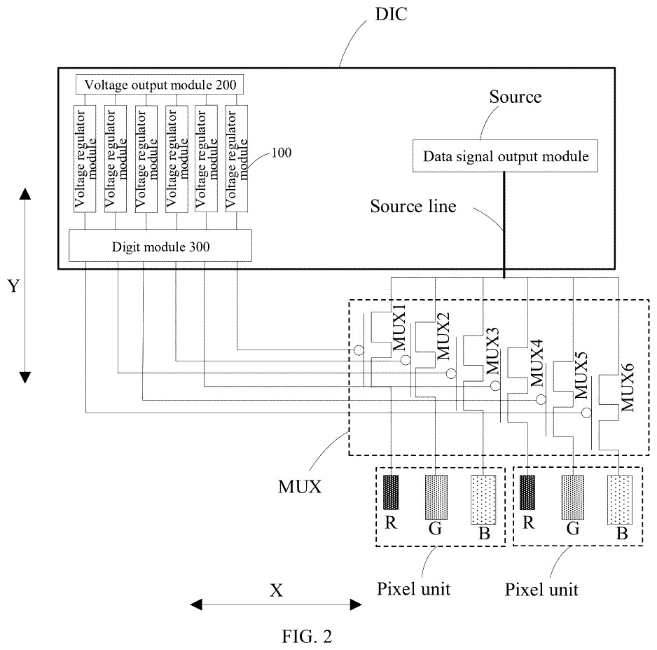

FIG. 1 is a schematic diagram of a structure of a display panel according to embodiments of the present disclosure, and FIG. 2 is a schematic diagram of connections between a switch circuit in FIG. 1 and other devices. As shown in FIGS. 1 and 2, the display panel can further include a source driving circuit ‘DIC’ and multiple switch circuits ‘MUX’. The switch circuit ‘MUX’ can include multiple switch modules. A control terminal of the switch module is used to receive a switch control signal, a first terminal of the switch module is used to receive a data signal, and a second terminal of the switch module is connected to the data line ‘Data’ in a display area AA. The source driving circuit ‘DIC’ can include a data signal output module ‘Source’ and multiple voltage regulator modules 100. The data signal output module ‘Source’ can be used to output a data signal through a source signal line ‘Source line’ connected to the data signal output module, and one source signal line ‘Source line’ is connected to each of the switch modules in one switch circuit ‘MUX’ in correspondence. The voltage regulator modules 100 can be used to output switch control signals. In some embodiments, the number of voltage regulator modules 100 is less than or equal to the number of switch modules in the switch circuit ‘MUX’, and the switch control signals output by at least some of the voltage regulator modules 100 have different signal amplitudes.

The display panel provided by the present disclosure includes a source driving circuit ‘DIC’ and a switch circuit ‘MUX’. One switch circuit ‘MUX’ includes multiple switch modules, and one switch module is connected to one data line ‘Data’ to output a data signal to a sub-pixel column. The source driving circuit ‘DIC’ includes multiple voltage regulator modules 100. The signal amplitude of the switch control signal output by the voltage regulator module 100 is proportional to the maximum grayscale voltage of the sub pixel corresponding to the switch control signal. In other words, the voltage regulator modules 100 corresponding to different sub pixels can output voltage signals of different signal amplitudes. Therefore, compared to the prior art where only voltage signals having the same signal amplitude are output to control different switch modules in the switch circuit, the source driving circuit ‘DIC’ provided by the present disclosure can reduce the overall power consumption.

As shown in FIG. 1, the display panel provided by the present disclosure can include a display area AA and a non-display area NA arranged at least on a side of the display area AA. The display area AA includes multiple pixel units arranged in an array along a row direction and a column direction. The pixel unit includes multiple types of sub pixels having different maximum grayscale voltages. The switch circuit ‘MUX’ and the source driving circuit ‘DIC’ can be located in the non-display area NA.

In the present disclosure, a signal amplitude of the switch control signal can be proportional to the maximum grayscale voltage of a sub pixel corresponding to the switch control signal. In the display field, the grayscale is used to represent a brightness level of a display screen. The brightness of the display screen does not change continuously, but changes according to predetermined brightness levels, which are the grayscale of the display screen. The driving integrated circuit ‘DIC’ can obtain the grayscale values of each pixel point in the image to be displayed through a motherboard connected to the driving integrated circuit. After obtaining the grayscale values of each pixel point, the driving integrated circuit ‘DIC’ can determine the grayscale voltage of the image to be displayed based on a binding point voltage in a built-in Gamma module. In some embodiments, each grayscale value corresponds to a grayscale voltage. The higher the grayscale value is, the greater the grayscale voltage corresponding thereto is, and correspondingly, the higher the display brightness is.

It can be understood that the same type of sub pixels has the same maximum grayscale voltage. The same type of sub pixels can be understood as sub pixels that display the same color. In some embodiments, a display panel can include three type of sub pixels, namely a first sub pixel, a second sub pixel, and a third sub pixel. The first sub pixel is the red (R) sub pixel, the second sub pixel is the green (G) sub pixel, and the third sub pixel is the blue (B) sub pixel. Therefore, the first sub pixels in the display panel are divided as a same type of sub pixels, the second sub pixels are divided as a same type of sub pixels, and the third sub pixels are divided as a same type of sub pixels. In some embodiments, each of the first sub pixels has a same maximum grayscale voltage, each of the second sub pixels has a same maximum grayscale voltage, and each of the third sub pixels has a same maximum grayscale voltage.

Different types of sub pixels have different maximum grayscale voltages. For example, taking the above display panel as an example, which includes three types of sub pixels, namely the first sub pixel R, the second sub pixel G, and the third sub pixel B, the maximum grayscale voltage of the first sub pixel R, the maximum grayscale voltage of the second sub pixel G, and the maximum grayscale voltage of the third sub pixel B are different from each other.

In the display panel provided by the present disclosure, the display area can include multiple pixel units arranged in an array along a row direction and a column direction. The row direction refers to a pixel row direction and the column direction refers to a pixel column direction. It can be understood that a sub-pixel column includes sub pixels that display the same color, that is, the sub pixels that have the same maximum grayscale voltage.

In some embodiments, one switch module is connected to one data line ‘Data’, so as to provide the data signal to a sub-pixel column. The sub-pixel column includes sub pixels of the same type. The control terminal of the switch module receives the switch control signal. That is, the switch control signal in the present disclosure and the type of the sub pixel are in a one-to-one correspondence. In some embodiments, one switch control signal controls the connection between sub pixels of the same type and the source signal line ‘Source line’.

The signal amplitude of the switch control signal output by the voltage regulator module 100 is proportional to the maximum grayscale voltage of the sub pixel corresponding to the switch control signal. It can be understood that the greater the maximum grayscale value of a sub pixel is, the greater the signal amplitude of the switch control signal received by the switch module that controls the sub pixel. In other words, the signal amplitude of the switch control signal received by the switch module corresponding to the sub pixel having higher maximum grayscale voltage can be greater than the signal amplitude of the switch control signal received by the switch module corresponding to the sub pixel having lower maximum grayscale voltage. In some embodiments, the signal amplitude of the switch control signal in the present disclosure can be determined based on the maximum grayscale voltage of the sub pixel corresponding to the switch control signal, so that the switch control signal can switch the corresponding switch module on. In some embodiments, the pixel unit includes the first sub pixel R, the second sub pixel G, and the third sub pixel B, and it is also known that the maximum grayscale voltage Vgreen of the sub pixel G>the maximum grayscale voltage Vred of the sub pixel R>the maximum grayscale voltage Vblue of the sub pixel B. In some embodiments, it is assumed that the switch module for controlling the sub pixel R is the first switch module, the switch module for controlling the sub pixel G is the second switch module, and the switch module for controlling the sub pixel B is the third switch module, and the first switch module is controlled by the first switch control signal, the second switch module is controlled by the second switch control signal, and the third switch module is controlled by the third switch control signal, respectively, then the signal amplitude of the second switch control signal can be greater than the signal amplitude of the first switch control signal, and the signal amplitude of the first switch control signal can be greater than the signal amplitude of the third switch control signal. In this way, the signal amplitude of each switch control signal can be set according to the maximum grayscale voltage of the sub pixel corresponding thereto, so that each voltage regulator module 100 can output a switch control signal that meets the requirements, thereby avoiding unnecessary power consumption caused by the signal amplitude of the switch control signal being greater than a switch-on voltage required. It can be understood that the switch circuit needs to be frequently switched off to output data signals to different pixel columns. In some embodiments, Mux 1:6 is taken as an example, that is, one switch circuit includes 6 switch modules. The resolution of the commonly used wearable product is 384×384, meaning that within one data frame, the number of switching on and off of the switch circuit ‘Mux’ corresponding to one source signal line ‘Source’=384×6=2304. There are 384×3/6=192 source signal lines ‘Source’ on the screen in total, and when the whole screen completes one refresh, the total number of switching on and off of the switch circuit ‘Mux’ is 2304×192=442368, the switching frequency being very high. When the source driving circuit ‘DIC’ only outputs the switch control signals having the same signal amplitude to control all switch modules, then the signal amplitude of the switch control signals would be greater than the actual signal amplitudes actually required by the switch module corresponding to the sub pixel B and the switch module corresponding to the sub pixel R. The high level of the switch control signal is usually 7V, and the low level of the switch control signal is usually −7V. The voltage of the switch control signal is relatively high, and considering the above number of switching on and off, it will ultimately cause the ‘Mux’ to consume a lot of power. Therefore, compared to the existing technology in which the source driving circuit ‘DIC’ only outputs the switch control signal having the same signal amplitude to control all switch modules, the source driving circuit ‘DIC’ provided by the present disclosure can reduce the power consumption of the switch module. That is, the display panel provided by the present disclosure has lower power consumption.

It should be understood that the sub pixel corresponding to the switch control signal described in the present disclosure can be understood as the switch module connected to the sub pixel being controlled by the switch control signal. For example, if the first sub pixel is connected to the first switch module, and the control terminal of the first switch module receives the first switch control signal, then the first sub pixel is the sub pixel corresponding to the first switch control signal.

The number of voltage regulator modules 100 is less than or equal to the number of switch modules in the switch circuit ‘MUX’. For example, if one switch circuit ‘MUX’ includes 6 switch modules, then the number of voltage regulator modules 100 in the source driving circuit ‘DIC’ is less than or equal to 6. Alternatively, if one switch circuit ‘MUX’ includes 9 switch modules, then the number of voltage regulator modules 100 in the source driving circuit ‘DIC’ is less than or equal to 9. In other words, in the present disclosure, the maximum number of voltage regulator modules 100 in the source driving circuit ‘DIC’does not exceed the number of switch modules in the switch circuit ‘MUX’.

The switch control signals output by at least some of the voltage regulator modules 100 have different signal amplitudes. In this way, the switch control signals output from each voltage regulator module 100 having the same voltage can be avoided, so that the voltage regulator modules 100 can output signals adapted to the maximum grayscale voltage of the corresponding sub pixel. In the present disclosure, it may be that some of the voltage regulator modules 100 output the switch control signals having the same signal amplitude, or it may be that each of the voltage regulator modules 100 may output the switch control signals having different signal amplitudes. For example, the source driving circuit ‘DIC’ can include six voltage regulator modules 100, among which, three voltage regulator modules 100 output switch control signals having different signal amplitudes, or the six voltage regulator modules 100 output the switch control signals having different signal amplitudes from each other.

The data signal output module ‘Source’ in the source driving circuit ‘DIC’ is connected to the source signal line ‘Source line’, to output data signals to the sub pixels in the display area AA through the source signal line ‘Source line’. In the present disclosure, one source signal line ‘Source line’ corresponds to and is connected to all switch modules in one switch circuit ‘MUX’. In this way, the number of source signal lines ‘Source line’ can be reduced, thereby reducing the space occupied by the source signal lines ‘Source line’, which is conducive to reducing the volume of the source driving circuit ‘DIC’. The saved space can be used to arrange other devices, which is conducive to reducing the overall volume of the display device.

Further explanations of embodiments of the present disclosure will be provided in the following with reference to the drawings.

As shown in FIG. 2, in some embodiments, the switch circuit ‘MUX’ can be a multiplexer, and the switch module can be a transistor. Under the control of each switch control signal, any transistor can be turned on to output the data signal from the data signal output module ‘Source’ to a corresponding sub-pixel column. One switch circuit ‘MUX’ can connect one source signal line ‘Source line’ in the source driving circuit ‘DIC’ to multiple data lines ‘Data’ in the display area AA, thereby reducing the number of source signal lines to be arranged and saving the space of the display panel at a neck of the non-display area ‘NA’.

In some embodiments, the switch modules in the switch circuit can be staggered along a row direction, as shown in FIG. 2. That is, the switch modules are not on the same straight line. Alternatively, switch modules connected to the same type of sub pixels are located in the same row, and switch modules connected to different types of sub pixels are not located in the same row. Alternatively, switch modules connected to the same pixel unit can be located in the same row, and switch modules connected to different pixel units can be staggered along the row direction.

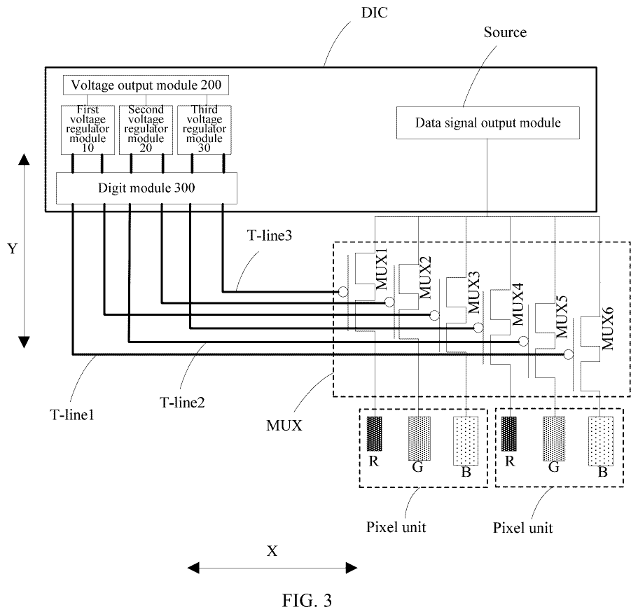

FIG. 3 is a schematic diagram of connections between the switch circuit in FIG. 1 and other devices in some other embodiments. As shown in FIG. 3, in some embodiments, the switch modules connecting the source signal lines ‘Source line’ to the sub pixels of the same type can share the same voltage regulator module 100. That is, switch modules connecting the source signal lines ‘Source line’ to the sub pixels of the same type use the same voltage regulator module 100 to output the switch control signal. In this way, the number of voltage regulator modules 100 to be arranged can be further reduced, thereby saving the space occupied by the source driving circuit ‘DIC’. For example, the display panel can include three types of sub pixels, namely the first sub pixel R, the second sub pixel G, and the third sub pixel B. The source driving circuit ‘DIC’ can include three voltage regulator modules, namely the first voltage regulator module 10, the second voltage regulator module 20, and the third voltage regulator module 30. The control terminals of the switch modules connecting the first sub pixel to the source signal line ‘Source line’ are all connected to the first voltage regulator module 10. The control terminals of the switch modules connecting the second sub pixel to the source signal line ‘Source line’ are all connected to the second voltage regulator module 20. The control terminals of the switch modules connecting the third sub pixel to the source signal line ‘Source line’ are all connected to the third voltage regulator module 30. The first voltage regulator module 10, the second voltage regulator module 20, and the third voltage regulator module 30 can independently set the switch-on voltages of the switch modules that control the RGB sub pixels in the switch circuit ‘MUX’. By comparing FIG. 2 and FIG. 3, it can be seen that according embodiments of the present disclosure, the number of voltage regulator modules 100 to be arranged can be reduced by sharing the voltage regulator modules 100, thereby saving the space of the source driving circuit ‘DIC’. The volume of the display panel can be further reduced by saving the space of the source driving circuit ‘DIC’, which is conducive to the miniaturization of the display device and improves the portability of the display device.

In some embodiments, a pixel unit can include m sub pixels, and a switch circuit can include n switch modules, where n is an integer multiple of m. For example, if the pixel unit includes three sub pixels, namely R, G, and B, then the switch circuit can include 3 switch modules, 6 switch modules, 9 switch modules, 12 switch modules, and so on.

In some embodiments, the number of voltage regulator modules 100 is the same as the number of sub pixels included in a pixel unit. For example, the pixel unit can include three sub pixels, namely the first sub pixel, the second sub pixel, and the third sub pixel. Therefore, the source driving circuit ‘DIC’ can include three voltage regulator modules, namely the first voltage regulator module 10 to the third voltage regulator module 30. In this way, the switch modules configured for controlling the same type of sub pixels in different switch circuits ‘MUX’ all share the same voltage regulator module 100, thereby minimizing the space occupied by the source driving circuit ‘DIC’.

As shown in FIG. 3, in some embodiments, the source driving circuit ‘DIC’ can further include multiple signal transmission lines T-line. One signal transmission line T-line is connected to one switch module, and the switch modules connected to the same type of sub pixels are connected to the same voltage regulator module 100 through corresponding signal transmission lines T-line. For example, as shown in FIG. 3, the multiple switch modules can include a first switch module MUX1 to a sixth switch module MUX6. The first switch module MUX1 and the fourth switch module MUX4 are both connected to the first sub pixel. Therefore, the first switch module MUX1 and the fourth switch module MUX4 are both connected to the third voltage regulator module 30 through respective signal transmission lines T-line. Similarly, the second switch module MUX2 and the fifth switch module MUX5 are both connected to the second voltage regulator module 20, and the third switch module MUX3 and the sixth switch module MUX6 are both connected to the first voltage regulator module 10.

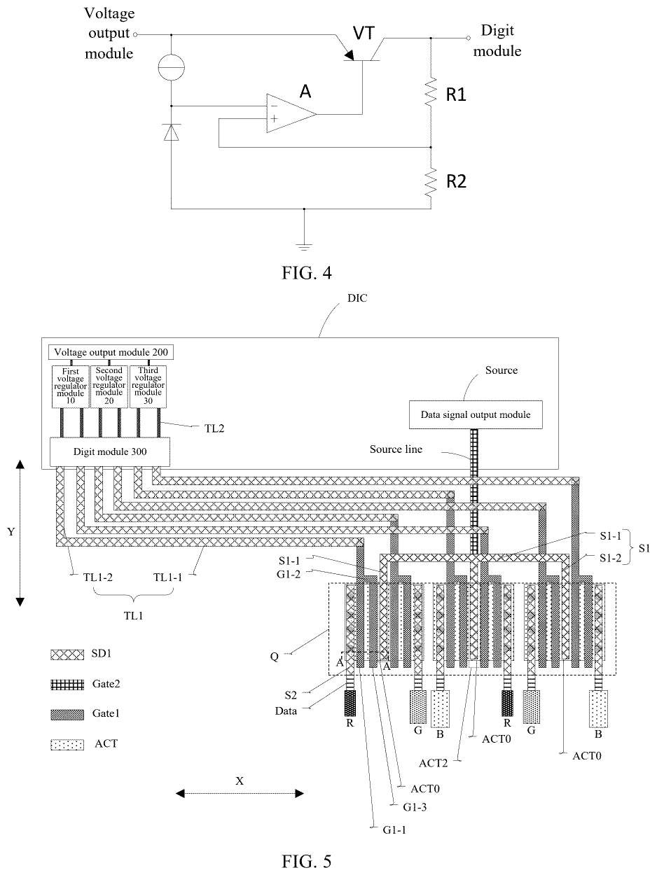

As shown in FIG. 3, in some embodiments, the source driving circuit ‘DIC’ can further include a voltage output module 200 and a digit module 300. The output terminal of the voltage output module 200 is connected to each of the voltage regulator modules 100. The voltage output module 200 can be used to output a reference voltage signal. The digit module 300 is connected to the voltage regulator modules 100 and the switch modules. The digit module 300 can be used to output switch control signals to the corresponding switch modules according to the preset timing. In some embodiments, the voltage output module 200 outputs the reference voltage signal, and then the voltage regulator module 100 adjusts the reference voltage signal into a switch control signal having a corresponding amplitude for output. For example, the voltage regulator module 100 can include a linear low dropout stabilizer LDO, and the circuit structure of the linear low dropout stabilizer LDO can be as shown in FIG. 4, which is composed of an adjustment tube VT, sampling resistors R1 and R2, and a comparison amplifier A connected in series. The specific principle of the linear low dropout stabilizer LDO can refer to the existing technology, and will not be repeated here. The input terminal of the linear low dropout stabilizer LDO is connected to the voltage output module 200, and the output terminal of the linear low dropout stabilizer LDO is connected to the digit module 300. The linear low dropout stabilizer LDO can stabilize the reference voltage signal into the switch control signal having the corresponding amplitude for output. For example, if the reference voltage signal is 7v and the signal amplitude of the switch control signal corresponding to the first sub pixel is 5v, then the linear low dropout stabilizer LDO can step down the reference voltage signal of 7v to a signal of 5v for output, so that the voltage regulator module 100 can output the switch control signal having the corresponding amplitude. On this basis, the signal transmission line T-line can include a first segment TL1 and a second segment TL2. The first segment TL1 is connected between the digit module 300 and the switch module, and the second segment TL2 is connected between the voltage regulator module 100 and the digit module 300. In some other embodiments, the voltage regulator module 100 can also be implemented through other buck and boost circuits, and the specific circuit structure of the voltage regulator module 100 is not particularly limited in the present disclosure.

In some embodiments, the signal transmission lines T-line corresponding to different types of sub pixels can have different arrangement orders. Taking the following as an example, where the first signal transmission line T-linel is connected to the switch module corresponding to the first sub pixel R, the second signal transmission line T-line2 is connected to the switch module corresponding to the second sub pixel G, and the third signal transmission line T-line3 is connected to the switch module corresponding to the third sub pixel B, then along the column direction, the signal transmission lines, in an order of a distance from the switch module from far to near, can be T-line1, T-line1, T-line2, T-line2, T-line3, and T-line3, or can be T-line3, T-line3, T-line2, T-line2, T-line1, and T-line1, or can be T-line2, T-line2, T-line1, T-line1, T-line3, and T-line3. In some embodiments, the arrangement order of the signal transmission lines can be adjusted according to the signal amplitudes of the switch control signals transmitted through the signal transmission lines. In some embodiments, because the signal amplitude on the second signal transmission line T-line2>the signal amplitude on the first signal transmission line T-line1>the signal amplitude on the third signal transmission line T-line3, then along the column direction, the signal transmission lines, in an order of a distance from the switch module from far to near, can be T-line2, T-line2, T-line1, T-line1, T-line3, and T-line3. In this way, the transmission distance of the signal transmission line on which a smaller signal amplitude is transmitted can be reduced, so that the switch control signal can still match the switch-on voltage required by the corresponding switch module after passing through the transmission line and after the voltage drop loss occurs, thereby avoiding the mismatch between the switch control signal and the switch-on voltage required by the switch module corresponding thereto due to the line loss.

It can be understood that usually the display panel further includes a gate driving circuit (not shown in the figure), which is used to perform the row scanning of the display panel. That is, the gate driving circuit can output the gate control signal to control each transistor in the same pixel row in the circuit to be turned on and perform the row scanning. In some embodiments, the gate driving circuit and the voltage regulator module can share the same voltage output module 200. That is, in the present disclosure, there is no need to add an additional voltage output module 200 in the source driving circuit ‘DIC’. By sharing the same voltage output module 200 with the gate driving circuit, the circuit structure can be simplified and the space can be saved.

As shown in FIG. 1, in some embodiments, the non-display area ‘NA’ of the display panel can include a transition area (i.e., the neck area shown in the figure) and a binding area (i.e., the pad area shown in the figure). The transition area is connected between the display area AA and the binding area. The width of the transition area in the first direction X is less than the width of the binding area in the first direction X. In some embodiments, the width of the transition area in the first direction X gradually decreases along a direction pointing from the binding area to the display area. The first direction X intersects with a direction of the overall extension of the display area AA towards the binding area. In some embodiments, the source driving circuit ‘DIC’ is located in the binding area, and the switch circuit ‘MUX’ is located in the transition area. The width of the transition area is less than the width of the binding area. In some embodiments, the width of the transition area can gradually decrease along the direction pointing from the binding area to the display area AA. According to embodiments of the present disclosure, the switch circuit ‘MUX’ is located in the transition area, and one switch circuit ‘MUX’ can connect one source data line ‘Data’ to multiple data lines ‘Data’, so that the space occupied by the source data line ‘Data’ can be reduced through the switch circuit ‘MUX’, thereby saving the space in the transition area. The direction of the overall extension of the display area AA towards the binding area can be a second direction Y. The first direction X intersects with the second direction Y. In some embodiments, the first direction X can correspond to the pixel row direction of the display area AA, and the second direction Y can correspond to the pixel column direction of the display area AA.

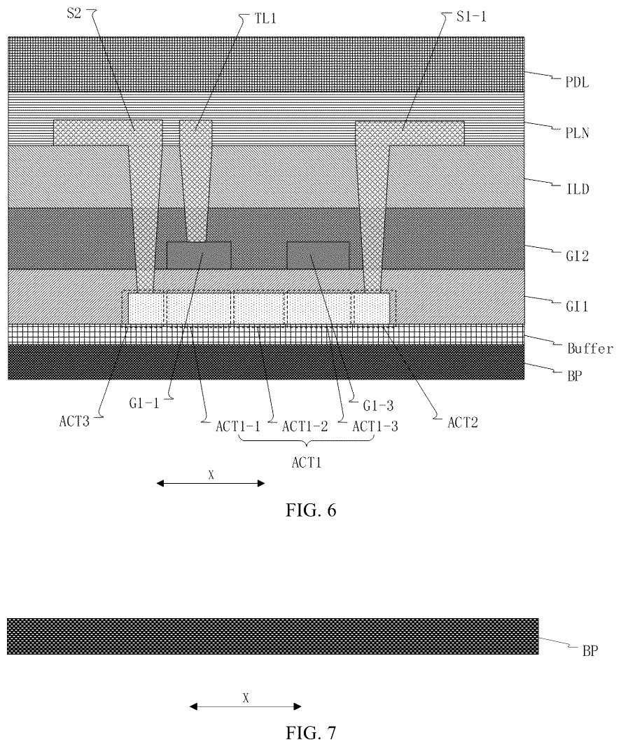

FIG. 5 is a schematic diagram of a structure of a switch circuit and other devices according to embodiments of the present disclosure, and FIG. 6 is a cross-sectional view taken along a dashed line AA in FIG. 5. As shown in FIGS. 5 and 6, in some embodiments, the display panel can include a base substrate BP, as well as an active layer ACT, a first conductive layer Gate1, a second conductive layer Gate2, and a third conductive layer SD1, the active layer ACT, the first conductive layer Gate1, the second conductive layer Gate2, and the third conductive layer SD1 being stacked in sequence on a side of the base substrate BP. The display panel can further include an insulating layer between adjacent two conductive layers. Further elaborated descriptions will not be provided here, and only the circuit structure used forming the switch circuit ‘MUX’ will be further introduced in the following.

In some embodiments, the active layer ACT can include multiple first active parts ACT1. The orthographic projections of the multiple first active parts ACT1 on the base substrate BP are distributed at intervals along the first direction X. The first active part ACT1 can include a first sub-active part ACT1-1, a second sub-active part ACT1-2, and a third sub-active part ACT1-3, which are connected in sequence along the first direction X. The first sub-active part ACT1-1 and the third sub-active part ACT1-3 are used to form the channel region of the switch module. The first conductive layer Gate1 can include multiple first conductive parts G1. The first conductive part G1 and the first active part ACT1 are arranged in one-to-one correspondence. The first conductive part G1 can include a first sub-conductive part G1-1, a second sub-conductive part G1-2, and a third sub-conductive part G1-3, which are connected in sequence. An orthographic projection of the first sub-conductive part G1-1 on the base substrate BP covers an orthographic projection of the first sub-active part ACT1-1 on the base substrate BP. An orthographic projection of the third sub-conductive part G1-3 on the base substrate BP covers an orthographic projection of the third sub-active part ACT1-3 on the base substrate BP. In some embodiments, the first sub-conductive part G1-1 and the third sub-conductive part G1-3 are used to form the control terminal of the switch module, and the second sub-conductive part G1-2 is connected between the first sub-conductive part G1-1 and the third sub-conductive part G1-3 on a side where the first sub-conductive part G1-1 and the third sub-conductive part G1-3 are away from the display area AA. In some embodiments, the first sub-conductive part G1-1 forms one control terminal of the switch module, and the third sub-conductive part G1-3 forms the other control terminal of the switch module, so that the switch module has a double-gate structure. By providing the switch module of the double-gate structure, the voltage stability of the control terminal of the switch module can be improved, the leakage current of the switch module can be reduced, and the source voltage crosstalk between RGB sub pixels can be reduced. The second sub-conductive part G1-2 connects the first sub-conductive part G1-1 to the third sub-conductive part G1-3, thereby electrically connecting the two control terminals of the switch module. The second sub-conductive part G1-2 connects the first sub-conductive part G1-1 to the third sub-conductive part G1-3 on a side where the first sub-conductive part G1-1 and the third sub-conductive part G1-3 are away from the display area AA, so that the first sub-conductive part G1-1 and the third sub-conductive part G1-3 form a parallel structure, and so that the switch module having dual control terminals is equivalent to be formed as two switches, thereby enhancing the ability to suppress the leakage current.

As shown in FIG. 5, in some embodiments, an orthographic projection of the second sub-conductive part G1-2 on the base substrate BP is separated from an orthographic projection of the second sub-active part ACT1-2 on the base substrate BP. That is, the orthographic projection of the second sub-conductive part G1-2 on the base substrate BP does not overlap with the orthographic projection of the second sub-active part ACT1-2 on the base substrate BP. Therefore, the second sub-conductive part G1-2 will not affect the current flowing through the switch module, and will not affect the performance of the switch module.

In some embodiments, the active layer ACT includes multiple repeating units Q. The number of repeating units Q is the same as the number of switch circuits ‘MUX’. The repeating unit Q includes f active structures ACT0, and one active structure ACT0 includes two first active parts ACT1. In some embodiments, the switch circuit ‘MUX’ includes k switch modules, when k is odd, f=(k+1)/2, and when k is even, f=k/2. In some embodiments, due to the fact that the active structures ACT0 in one repeating unit Q is used to form the channel regions of each of the switch modules in one switch circuit ‘MUX’, the number of repeating units Q is the same as the number of switch circuits ‘MUX’. One active structure ACT0 includes two first active parts ACT1. That is, the channel regions of two switch modules are connected together through the active structure. Therefore, two adjacent switch modules can use the same conductive structure to be connected to the source data line. In this way, every two switch modules can be connected to the source data line by sharing the same conductive structure. In some embodiments, the switch circuit ‘MUX’ includes k switch modules, when k is odd, f=(k+1)/2, and when k is even, f=k/ 2. For example, if the switch circuit ‘MUX’ includes 6 switch modules, then the repeating unit Q can include 3 active structures ACT0. Alternatively, if the switch circuit ‘MUX’ includes 9 switch modules, then the repeating unit Q can include 5 active structures ACT0.

It should be understood that in some embodiments, one active structure ACT0 includes two first active parts ACT1, that is, the channel regions of two switch modules are connected together through the active structure. Compared to the technology where one active structure corresponds to one first active part and forms the channel region of one switch module, the process steps can be simplified. Moreover, when one active structure corresponds to and forms the channel region of one switch module, the number of active structures increases, meaning that the gap will also increase. Therefore, compared to the above technology, the solutions provided by the present disclosure can save space and further reduce the space occupied by the switch circuit. In some embodiments of the present disclosure, the two channel regions are connected together through the active structure, and thus the gap between adjacent active structures can be increased, which is more conducive to the heat dissipation.

In some embodiments, the active structure ACT0 can further include one second active part ACT2 and two third active parts ACT3. The second active part ACT2 is connected between two adjacent first active parts ACT1, and can be used to form the first terminals of two adjacent switch modules. The two third active parts ACT3 each is connected to a side where one first active part ACT1 is away from the other first active part ACT1. The third active parts ACT3 can be used to form the second terminals of two adjacent switch modules. That is, the second active part ACT2 is located in the middle of the active structure ACT0, serving as the first terminals of two switch modules. The third active parts ACT3 are located on both sides of the active structure ACT0, respectively serving as the second terminals of two switch modules. Therefore, the first terminals of two adjacent switch modules can be both connected to the source signal line ‘Source line’ by connecting the second active part ACT2 to the source signal line ‘Source line’, and the second terminals of two adjacent switch modules can be connected to the corresponding signal transmission lines T-line by connecting the third active parts ACT3 to the signal transmission lines T-line.

In some embodiments, the second conductive layer Gate2 can include multiple source signal lines ‘Source line’. Orthographic projections of the source signal lines ‘Source line’ on the base substrate BP extend along the second direction Y and are distributed at intervals along the first direction X. One source signal line ‘Source line’ corresponds to one repeating unit Q of the active layer ACT, that is, one source signal line ‘Source line’is connected to each of the switch modules in one switch circuit ‘MUX’.

In some embodiments, the third conductive layer SD1 can include multiple first trans-connection lines S1, multiple signal transmission lines T-lines, and multiple second trans-connection lines.

The first trans-connection line S1 can include a first connection part S1-1 and multiple second connection parts S1-2. An orthographic projection of the first connection part S1-1 on the base substrate BP extends along the first direction X. The multiple second connection parts S1-2 and the multiple second active parts ACT2 are in one-to-one correspondence. The multiple second connection parts S1-2 are connected to the first connection part S1-1, and orthographic projections of the second connection parts S1-2 on the base substrate BP extend along the second direction Y. The second connection parts S1-2 are also connected to the corresponding second active parts ACT2 through via holes, so as to be connected to the first terminals of two switch modules, and then the first terminals of the two switch modules are connected to the source signal line ‘Source line’through the first connection part S1-1.

As mentioned above, the signal transmission line T-line can include a first segment TL1 and a second segment TL2. The first segment TL1 is connected between the digit module and the switch module, and the second segment TL2 is connected between the voltage regulator module and the digit module. The first segment TL1 can include a first transmission part TL1-1 and a second transmission part TL1-2. An orthographic projection of the first transmission part TL1-1 on the base substrate BP extends along the first direction X, and the first transmission part TL1-1 is connected to the corresponding first sub-conductive part G1-1 through a via hole. The second transmission part TL1-2 is connected to the first transmission part TL1-1 and the corresponding voltage regulator module 100. An orthographic projection of the second transmission part TL1-2 on the base substrate BP extends along the second direction Y. That is, the signal transmission line T-line is connected to the control terminal of the corresponding switch module through the first transmission part TL1-1, and then connected to the voltage regulator module 100 through the second transmission part TL1-2, thereby connecting the control terminal of the switch module to the corresponding voltage regulator module 100. It should be understood that because the source driving circuit ‘DIC’ also includes the digit module 300, the second transmission part TL1-2 of the signal transmission line T-line is first connected to the digit module 300 and then connected to the voltage regulator module 100.

The multiple second trans-connection lines S2 are arranged in one-to-one correspondence with the third active parts ACT3. Orthographic projections of the multiple second trans-connection lines S2 on the base substrate BP extend along the second direction Y and are distributed at intervals along the first direction X. The second trans-connection lines S2 are connected to the corresponding third active parts ACT3 through via holes, and are connected to the corresponding data lines ‘Data’. In one aspect, the second trans-connection line S2 can be connected to the third active part ACT3 through via holes, so as to be connected to the first terminal of the switch module. In another aspect, the second trans-connection line S2 can be connected to the data line ‘Data’, so as to connect the first terminal of the switch module to the data line ‘Data’ in the display area AA. In addition, the second segment TL2 and the first segment TL1 can be located in the same conductive layer or in different conductive layers, which is not specially limited by the present disclosure.

As mentioned above, the first terminal of the switch module is connected to the data line ‘Data’ in the display area AA through the second trans-connection line S2, the second terminal of the switch module is connected to the source signal line ‘Source line’ through the first trans-connection line S1, and the control terminal of the switch module is connected to the voltage regulator module 100 through the signal transmission line T-line.

The present disclosure also provides a method for manufacturing a display panel, which is used to manufacture the display panel described in the above embodiments of the present disclosure. The method for manufacturing the display panel can include the following steps.

As shown in FIG. 7, in step S110, a base substrate BP is provided. The base substrate BP has a display area AA and a non-display area NA located at least on a side of the display area AA. The display area AA includes multiple pixel units arranged in an array along the row direction and the column direction. The pixel unit includes multiple types of sub pixels having different maximum grayscale voltages.

In some embodiments, the base substrate BP can include flexible plastic. For example, the base substrate BP can include polyether sulfone (PES), polyallyl ester, polyimide (PI), etc.

In step S120, an active layer ACT is formed on a side of the base substrate BP by using a deposition process. The active layer ACT includes multiple first active parts ACT1. Orthographic projections of the multiple first active parts ACT1 on the base substrate BP are distributed at intervals along the first direction X. The first active part ACT1 includes a first sub-active part ACT1-1, a second sub-active part ACT1-2, and a third sub-active part ACT1-3, which are connected in sequence along the first direction X. The first sub-active part ACT1-1 and the third sub-active part ACT1-3 are used to form the channel regions of the switch module.

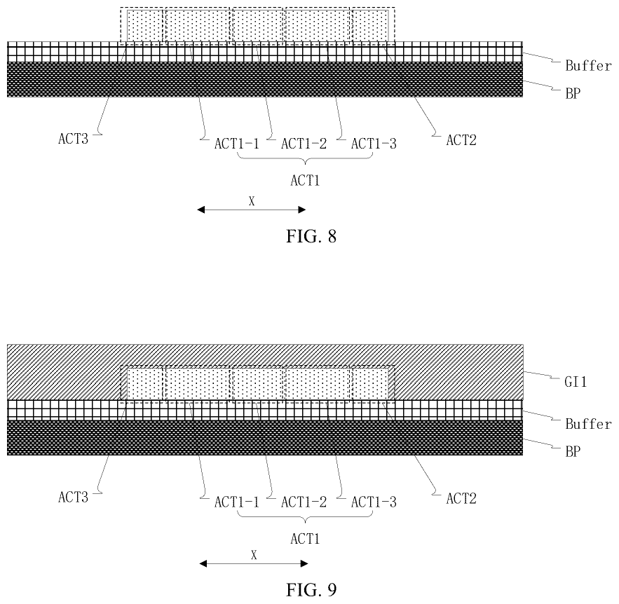

In some embodiments, as shown in FIG. 8, before forming the active layer ACT, a buffer layer ‘Buffer’ can also be formed on the base substrate BP. The buffer layer ‘Buffer’ can cover the base substrate BP as a whole to form a flat surface. Therefore, the buffer layer ‘Buffer’can include materials that can form the flat surface.

Then, as shown in FIG. 8, a semiconductor material is deposited on the buffer layer ‘Buffer’ using a deposition process to form the active layer ACT. The semiconductor material can be LTPS materials or LTPO materials, etc., which is not specially limited by the present disclosure. A patterning process is further used to pattern the active layer ACT, forming the above structure of the active layer ACT.

In some embodiments, multiple active structures ACT0 having gaps can be formed in the active layer ACT using a patterning process. One active structure ACT0 can include two first active parts ACT1. That is, the channel regions of two switch modules are connected together through the structure of the active layer ACT. In this way, two adjacent switch modules can share the same conductive structure to be connected to the source data line ‘Data’.

In some embodiments, the active structure ACT0 formed can further include one second active part ACT2 and two third active parts ACT3. The second active part ACT2 is connected between two adjacent first active parts ACT1, and can be used to form the first terminals of two adjacent switch modules. The two third active parts ACT3 each is connected to a side where one first active part ACT1 is away from the other first active part ACT1, and the third active parts ACT3 can be used to form the second terminals of the two adjacent switch modules. That is, the second active part ACT2 is located in the middle of the active structure ACT0, serving as the first terminals of the two switch modules. The third active parts ACT3 are located on both sides of the active structure ACT0, respectively serving as the second terminals of the two switch modules. Therefore, the first terminals of two adjacent switch modules can be both connected to the source signal line ‘Source line’ by connecting the second active part ACT2 to the source signal line ‘Source line’, and the second terminals of two adjacent switch modules can be connected to the corresponding signal transmission lines T-line by connecting the third active parts ACT3 to the signal transmission lines T-line.

In some embodiments, the thickness of the first semiconductor layer can be 10-100 nm, such as 10 nm, 30 nm, 50 nm, 70 nm, 80 nm, 100 nm, etc.

In step 130, a first conductive layer Gate1 is formed on a side of the active layer ACT facing away from the base substrate BP by using a deposition process. The first conductive layer Gate1 includes multiple first conductive parts G1. The first conductive parts G1 and the first active parts ACT1 are arranged in one-to-one correspondence. The first conductive part G1 includes a first sub-conductive part G1-1, a second sub-conductive part G1-2, and a third sub-conductive part G1-3, which are connected in sequence. An orthographic projection of the first sub-conductive part G1-1 on the base substrate BP covers an orthographic projection of the first sub-active part ACT1-1 on the base substrate BP. An orthographic projection of the third sub-conductive part G1-3 on the base substrate BP covers an orthographic projection of the third sub-active part ACT1-3 on the base substrate BP. The first sub-conductive part G1-1 and the third sub-conductive part G1-3 are used to form the control terminals of the switch module. In some embodiments, the second sub-conductive part is connected between the first sub-conductive part G1-1 and the third sub-conductive part G1-3 on a side where the first sub-conductive part G1-1 and the third sub-conductive part G1-3 are away from the display area AA.

In some embodiments, as shown in FIG. 9, before the first conductive layer Gate1 is formed, a first gate insulating layer GI1 can be formed on a side of the buffer layer ‘Buffer’ facing away from the base substrate BP by using a deposition process. For example, an entire first gate insulating layer GI1 can be formed on a side of the active layer ACT facing away from the base substrate BP by using a magnetron sputtering process (Sputter). The first gate insulating layer GI1 covers the active layer ACT. The material of the first gate insulating layer GI1 can be, for example, SiOx, etc. The thickness of the first gate insulating layer GI1 can be, for example, 50 -150 nm, such as 50 nm, 70 nm, 90 nm, 100 nm, 110 nm, 120 nm, 140 nm, 150 nm, etc.

As shown in FIG. 10, then a first conductive layer Gate1 can be formed by depositing a metal material using the Sputter process. The material of the first conductive layer Gate1 can be Mo, etc. Then, the first conductive layer Gate1 is patterned using a patterning process, to form a switch module having the double-gate structure as described in the above. By providing the switch module to be of the double-gate structure, the voltage stability of the control terminal of the switch module can be improved, the leakage current of the switch module can be reduced, and the source voltage crosstalk between RGB sub pixels can be reduced.

In some embodiments, the thickness of the first conductive layer Gate1 can be, for example, 200-300 nm, such as 200 nm, 230 nm, 250 nm, 270 nm, 290 nm, 300 nm, etc.

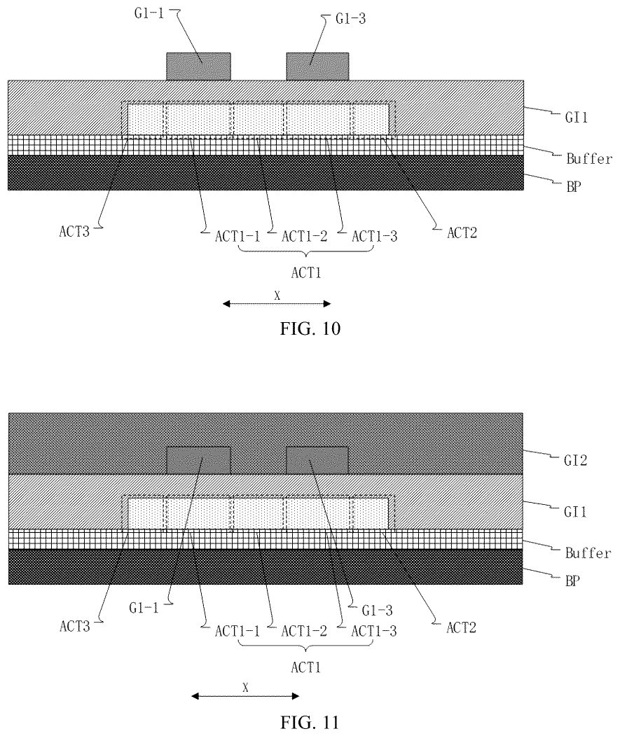

In some embodiments, as shown in FIG. 11, a plasma enhanced chemical vapor deposition (PECVD) process can be used to deposit and form a second gate insulating layer GI2. The second gate insulating layer GI2 is located on a side of the first conductive layer Gate1 facing away from the base substrate BP, and covers the first conductive layer Gate1. The material of the second gate insulating layer GI2 can be SiNx, etc. The thickness of the second gate insulating layer GI2 can be 50 -150 nm, such as 50 nm, 70 nm, 90 nm, 110 nm, 130 nm, 140 nm, 150 nm, etc.

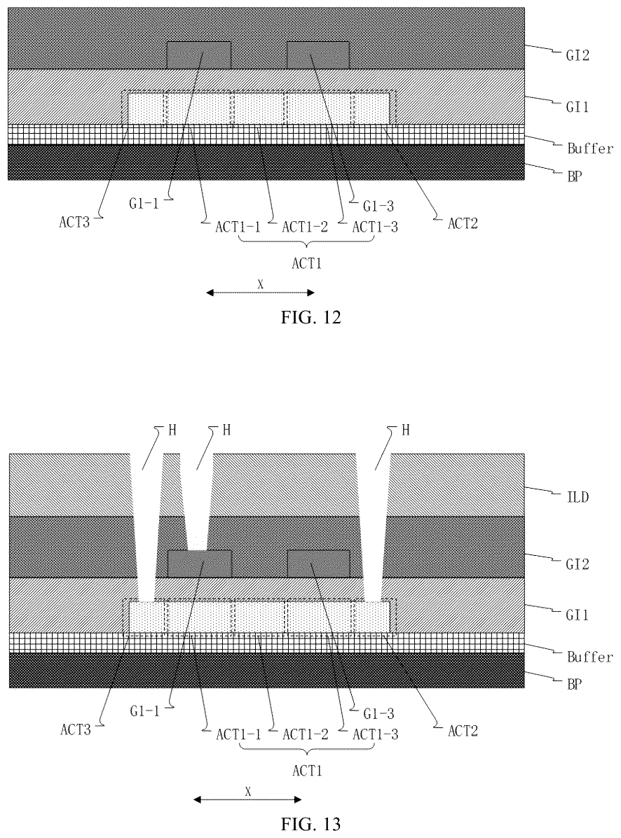

In some embodiments, as shown in FIG. 12, after the second gate insulating layer GI2 is formed, a metal material can be deposited by using the Sputter process to form a second conductive layer Gate2. The material of the second conductive layer Gate2 can be, for example, Mo, etc. The second conductive layer Gate2 is then patterned by using a patterning process.

In some embodiments, as shown in FIG. 13, after the second conductive layer Gate2 is formed, an interlayer insulating layer ILD can be formed on a side of the second conductive layer Gate2 facing away from the base substrate BP by using a PECVD process. The material of the interlayer insulating layer ILD can include, for example, SiNx, SiOx, etc. The CNT drilling process is performed to form multiple via holes H to expose the first sub-conductive part G1-1 in the first conductive layer Gate1, and the second active part ACT2 and the third active part ACT3 in the active layer ACT, which are correspondingly connected to the source signal line ‘Source line’ and signal transmission line T-line in a third conductive layer SD1. The thickness of the interlayer insulating layer ILD can be between 150-350 nm, such as 150 nm, 200 nm, 250 nm, 300 nm, etc.

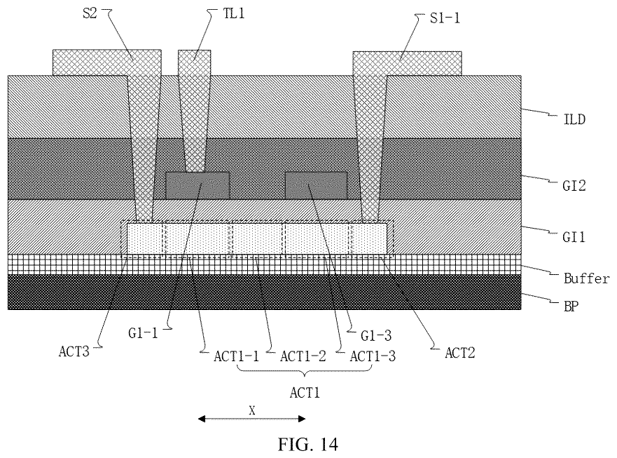

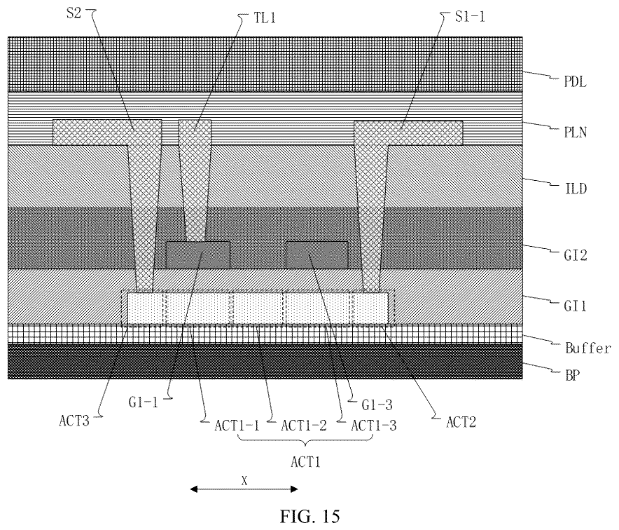

In some embodiments, as shown in FIG. 14, after the interlayer insulating layer ILD is formed, a third conductive layer SD1 can be formed by depositing a conductive material using the Sputter process. The material of the third conductive layer SD1 can include a metal material, such as one of molybdenum, aluminum, copper, titanium, niobium, or an alloy thereof, or a molybdenum/titanium alloy or stack, or a titanium/aluminum/titanium stack. The third conductive layer SD1 is further patterned to obtain the multiple first trans-connection lines S1, the multiple signal transmission lines T-line, and the multiple second trans-connection lines as described in the above embodiments. In some embodiments, the third conductive layer SD1 is a titanium/aluminum/titanium stacked structure, and the thickness of each layer can be 50 nm, 550 nm, and 30 nm, respectively.

In some embodiments, as shown in FIG. 15, after the third conductive layer SD1 is formed, a planarization layer PLN, a pixel definition layer PDL, etc. can also be formed on a side of the third conductive layer SD1 facing away from the base substrate BP by using spin coating, exposure, development, and curing processes.

The present disclosure also provides a display device. The display device can include the display panel described in any of the above embodiments of the present disclosure. The display device can be, for example, a flexible wearable device, such as a watch, etc.

After considering the specification and practicing of the invention disclosed herein, those skilled in the art will easily come up with other implementation solutions of the present disclosure. The present disclosure intends to cover any variations, uses, or adaptive changes of the present disclosure, which follow the general principles of the present disclosure and include common knowledge or commonly used technical means in the art that are not disclosed in the present disclosure. The specification and embodiments are only considered as exemplary, and the true scope and the spirit of the present disclosure are defined by appended claims.

1. A display panel, comprising:
multiple switch circuits, wherein each switch circuit comprises:
multiple switch modules, wherein a control terminal of each switch module is configured to receive a switch control signal, a first terminal of the switch module is configured to receive a data signal, and a second terminal of the switch module is connected to a data line in a display area;
a source driving circuit, wherein the source driving circuit comprises:
a data signal output module configured to output the data signal through source signal lines connected thereto, wherein each source signal line corresponds to each switch circuit, and the source signal line is connected to the switch modules in the switch circuit corresponding thereto; and
multiple voltage regulator modules configured to output the switch control signal;
wherein a number of the voltage regulator modules is less than or equal to a number of switch modules in the switch circuit, and switch control signals output by at least some of the voltage regulator modules have different signal amplitudes.

2. The display panel according to claim 1, comprising the display area and a non-display area arranged at least on a side of the display area, wherein the display area comprises multiple pixel units arranged in an array along a row direction and a column direction, each pixel unit comprises multiple types of sub pixels having different maximum grayscale voltages, and the switch circuits and the source driving circuit are both located in the non-display area; and
wherein a signal amplitude of the switch control signal is proportional to a maximum grayscale voltage of a sub pixel corresponding to the switch control signal.

3. The display panel according to claim 1, wherein switch modules connecting the same type of sub pixels to the source signal lines share the same voltage regulator module.

4. The display panel according to claim 3, wherein the number of the voltage regulator modules is the same as a number of the sub pixels in a pixel unit.

5. The display panel according to claim 4, wherein the pixel unit comprises a first sub pixel (R), a second sub pixel (G), and a third sub pixel (B), and a maximum grayscale voltage of the second sub pixel>a maximum grayscale voltage of the first sub pixel>a maximum grayscale voltage of the third sub pixel; and
wherein the source driving circuit comprises a first voltage regulator module configured to output a first switch control signal, a second voltage regulator module configured to output a second switch control signal, and a third voltage regulator module configured to output a third switch control signal, and a signal amplitude of the second switch control signal >a signal amplitude of the first switch control signal >a signal amplitude of the third switch control signal.

6. The display panel according to claim 4, wherein the pixel unit comprises m sub pixels, and the switch circuit comprises n switch modules, where n and m are natural numbers, and n is an integer multiple of m; and
wherein the source driving circuit further comprises multiple signal transmission lines, each signal transmission line is connected to each switch module, and switch modules connected to the same type of sub pixels are connected to the same voltage regulator module through signal transmission lines corresponding thereto.

7. The display panel according to claim 6, wherein the source driving circuit further comprises:
a voltage output module, wherein an output terminal of the voltage output module is connected to the voltage regulator modules, and the voltage output module is configured to output a reference voltage signal; and
a digit module connected to the voltage regulator modules and the switch modules, wherein the digit module is configured to output the switch control signal to a switch module corresponding to the switch control signal according to a preset timing;
wherein the voltage regulator modules are further configured to adjust the reference voltage signal into a switch control signal having a corresponding amplitude;
the signal transmission line comprises a first segment and a second segment, the first segment is connected between the digit module and the switch module, and the second segment is connected between the voltage regulator module and the digit module.

8. The display panel according to claim 7, further comprising a gate driving circuit, wherein the gate driving circuit is configured to perform row scanning of the display panel; and
wherein the gate driving circuit and the voltage regulator modules share the same voltage output module.

9. The display panel according to claim 1, wherein a voltage regulator circuit comprises a linear low dropout regulator.

10. The display panel according to claim 1, wherein the switch circuit comprises a multiplexer, and the switch module comprises a transistor.

11. The display panel according to claim 2, wherein the non-display area comprises a transition area and a binding area, the transition area is connected between the display area and the binding area, the source driving circuit is located in the binding area, and the switch circuits are located in the transition area; and
wherein a width of the transition area in a first direction is less than a width of the binding area in the first direction, and the first direction intersects with an overall extension direction from the display area to the binding area.

12. The display panel according to claim 11, wherein the width of the transition area in the first direction gradually decreases along a direction pointing from the binding area to the display area.

13. The display panel according to claim 11, further comprising:
a base substrate;
an active layer located on a side of the base substrate, wherein the active layer comprises:
multiple first active parts, wherein orthographic projections of the first active parts on the base substrate are distributed at intervals along the first direction, each first active part comprises a first sub-active part, a second sub-active part, and a third sub-active part, connected in sequence along the first direction, and the first sub-active part and the third sub-active part are used to form channel regions of the switch module;
a first conductive layer located on a side of the active layer away from the base substrate, wherein the first conductive layer comprises:
multiple first conductive parts arranged in one-to-one correspondence with the first active parts, wherein each first conductive part comprises a first sub-conductive part, a second sub-conductive part, and a third sub-conductive part, connected in sequence, an orthographic projection of the first sub-conductive part on the base substrate covers the orthographic projection of the first sub-active part on the base substrate, an orthographic projection of the third sub-conductive part on the base substrate covers the orthographic projection of the third sub-active part on the base substrate, and the first sub-conductive part and the third sub-conductive part are used to form a control terminal of the switch module;
wherein the second sub-conductive part is connected between the first sub-conductive part and the third sub-conductive part on a side where the first sub-conductive part and the third sub-conductive part are away from the display area.

14. The display panel according to claim 13, wherein an orthographic projection of the second sub-conductive part on the base substrate is separated from an orthographic projection of the second sub-active part on the base substrate.

15. The display panel according to claim 13, wherein the active layer comprises multiple repeating units, a number of the repeating units is the same as a number of the switch circuits, each repeating unit comprises f active structures, and each active structure comprises two first active parts; and
wherein each switch circuit comprises k switch modules, if k is odd, f=(k+1)/2, and if k is even, f=k/2;
wherein f and k are natural numbers.

16. The display panel according to claim 15, wherein the active structure further comprises:
a second active part connected between two adjacent first active parts, wherein the second active part is used to form first terminals of two adjacent switch modules; and
two third active parts each connected to a side where one of the first active parts is away from the other one of the first active parts, wherein the third active parts are used to form second terminals of the two adjacent switch modules; and
wherein the display panel further comprises:
a second conductive layer located on a side of the first conductive layer away from the base substrate, wherein the second conductive layer comprises:
the source signal lines, wherein orthographic projections of the source signal lines extend along a second direction and are distributed at intervals along the first direction;
a third conductive layer located on a side of the second conductive layer away from the base substrate, wherein the third conductive layer comprises:
multiple first trans-connection lines, wherein each first trans-connection line and each source signal line are in one-to-one correspondence, and the first trans-connection line comprises:
a first connection part, wherein an orthographic projection of the first connection part on the base substrate extends along the first direction; and
multiple second connection parts, wherein the multiple second connection parts are in one-to-one correspondence with multiple second active parts and are connected to the first connection part, orthographic projections of the second connection parts on the base substrate extend along the second direction, and the second connection parts are further connected to the second active parts corresponding thereto through via holes;
multiple signal transmission lines, wherein the signal transmission line comprises:
a first transmission part, wherein an orthographic projection of the first transmission part on the base substrate extends along the first direction, and the first transmission part is connected to the first sub-conductive part corresponding thereto through a via hole; and
a second transmission part connected to the first transmission part and the voltage regulator module corresponding thereto, and an orthographic projection of the second transmission part on the base substrate extends along the second direction; and
multiple second trans-connection lines arranged in one-to-one correspondence with the third active parts, wherein orthographic projections of the second trans-connection lines on the base substrate extend along the second direction and are distributed at intervals along the first direction, and the second trans-connection lines are connected to the third active parts corresponding thereto through via holes and to the data lines corresponding thereto.

17. A method for manufacturing a display panel, wherein the method is used to manufacture the display panel according to claim 13, the method comprising:
providing a base substrate, wherein the base substrate has a display area and a non-display area located at least on a side of the display area, the display area comprises multiple pixel units arranged in an array along a row direction and a column direction, and each pixel unit comprises multiple types of sub pixels having different maximum grayscale voltages;
forming an active layer on a side of the base substrate using a deposition process, wherein the active layer comprises multiple first active parts, orthographic projections of the multiple first active parts on the base substrate are distributed at intervals along a first direction, each first active part comprises a first sub-active part, a second sub-active part, and a third sub-active part, which are connected in sequence along the first direction, and the first sub-active part and the third sub-active part are used to form channel regions of a switch module; and
forming a first conductive layer on a side of the active layer away from the base substrate using a deposition process, wherein the first conductive layer comprises multiple first conductive parts, and the first conductive parts and the first active parts are arranged in one-to-one correspondence, and wherein each first conductive part comprises a first sub-conductive part, a second sub-conductive part, and a third sub-conductive part, which are connected in sequence, an orthographic projection of the first sub-conductive part on the base substrate covers an orthographic projection of the first sub-active part on the base substrate, an orthographic projection of the third sub-conductive part on the base substrate covers an orthographic projection of the third sub-active part on the base substrate, the first sub-conductive part and the third sub-conductive part are used to form control terminals of the switch module, and the second sub-conductive part is connected between the first sub-conductive part and the third sub-conductive part on a side where the first sub-conductive part and the third sub-conductive part are away from the display area.

18. A display device comprising a display panel, wherein the display panel comprises:
multiple switch circuits, wherein each switch circuit comprises:
multiple switch modules, wherein a control terminal of each switch module is configured to receive a switch control signal, a first terminal of the switch module is configured to receive a data signal, and a second terminal of the switch module is connected to a data line in a display area;
a source driving circuit, wherein the source driving circuit comprises:
a data signal output module configured to output the data signal through source signal lines connected thereto, wherein each source signal line corresponds to each switch circuit, and the source signal line is connected to the switch modules in the switch circuit corresponding thereto; and
multiple voltage regulator modules configured to output the switch control signal;
wherein a number of the voltage regulator modules is less than or equal to a number of switch modules in the switch circuit, and switch control signals output by at least some of the voltage regulator modules have different signal amplitudes.

19. The display device according to claim 18, comprising the display area and a non-display area arranged at least on a side of the display area, wherein the display area comprises multiple pixel units arranged in an array along a row direction and a column direction, each pixel unit comprises multiple types of sub pixels having different maximum grayscale voltages, and the switch circuits and the source driving circuit are both located in the non-display area; and
wherein a signal amplitude of the switch control signal is proportional to a maximum grayscale voltage of a sub pixel corresponding to the switch control signal.

20. The display device according to claim 18, wherein switch modules connecting the same type of sub pixels to the source signal lines share the same voltage regulator module.
